(19) United States
(12) Patent Application Publication
(10) Pub. No.: US 2008/0044538 A1
(43) Pub. Date: Feb. 21, 2008

(54) Method For Pigment Solubilization, A pigment Composition And Its Use

(75) Inventor: Dennis Selse, Myggenas (SE)

Correspondence Address: AKZO NOBEL INC., INTELLECTUAL PROPERTY DEPARTMENT, 120 WHITE PLAINS ROAD 3RD FLOOR, TARRTOWN, NY, 10591, US

(73) Assignee: AKZO NOBEL N.V., Arnhem (NL)

(21) Appl. No.: 11/660,347

(22) PCT Filed: Aug. 24, 2005
(86) PCT No.: PCT/EP05/54145

§ 371 Date: Feb. 15, 2007

(30) Foreign Application Priority Data
Aug. 31, 2004 (EP) 04077425.9

(51) Int. Cl. A23K 1/16; A23D 7/005; A23D 7/01; A23D 9/00; A23D 9/013; A23K 1/00

(52) U.S. Cl. 426/540; 426/429; 426/430; 426/442; 426/602; 426/612; 426/658

(57) ABSTRACT

The present invention relates to an improved method for solubilizing an oil-soluble pigment efficiently in an oil or fat by extraction of a solid preparation containing the oil-soluble pigment, where the extraction takes place in the presence of water, an edible oil or fat and a nonionic surfactant. It also relates to the composition prepared by the extraction, and the use of this composition in animal feed to produce feed pellets. The combination of water and nonionic surfactant increases the amount of pigment that is extracted and solubilized. In detail the process of the invention relates to a method for solubilizing an oil-soluble pigment into an oil or fat by extraction of a solid preparation containing the oil-soluble pigment comprising the steps of a) mixing the solid preparation containing the pigment with water, an extraction medium containing an edible oil or fat, and a nonionic surfactant having a hydrocarbyl group, an acyl group or a substituted hydrocarbyl or acyl group containing at least 6 carbon atoms b) optionally centrifugalize the mixture obtained and separate the oil phase. The originally obtained mixture or the separated oil phase may then be added to porous precursor feed pellets to produce feed pellets. These pellets will have a higher amount of oil-soluble pigment available for uptake into the animal.

The present invention relates to an improved method for solubilizing an oil-soluble pigment efficiently in an oil or fat by extraction of a solid preparation containing the oil-soluble pigment, where the extraction takes place in the presence of water, an edible oil or fat and a nonionic surfactant. It also relates to the composition prepared by the extraction, and the use of this composition in animal feed to produce feed pellets. The combination of water and nonionic surfactant increases the amount of pigment that is extracted and solubilized.

In animal feed compositions, pigments are often added to endow an appealing colour to the meat or skin of the animals consuming the feed. The pigments used may be natural, synthesized or fermented, and commonly they are oil-soluble. An example of a class of oil-soluble pigments is the carotenoids, e.g. astaxanthin, canthaxanthin and β-carotene. These are insoluble in water, and have a low solubility in organic solvents, fats and oils. Astaxanthin and canthaxanthin are commonly used in fish feed to improve the flesh colour of salmonids, but also give rise to health benefits. Other uses for pigment in animal feed is for the coloration of the skin of some marine warm-water or tropical freshwater fishes, e.g. of the red seabream, and to endow a pink color to the shell and flesh of prawns. In addition to these aqua-cultural uses, the coloring of egg yolks and of the skin of broilers are other feed application areas.

Conventional feed pellets are usually formed from a solid base material, which may be protein-based such as fishmeal or carbohydrate-based such as starch, and where the base material is loaded with a fat or an oil component. The fat or oil, that could be either of animal or vegetable origin, is loaded into pores of the precursor feed pellets formed from the base material. The fat or oil increases the energy content of the feed. Other ingredients of the feed are e.g. vitamins, minerals, enzymes and the above-mentioned pigments. These latter ingredients, as well as the fat or oil, are preferably added after the pelletizing step, since the oil component interferes with the pelletizing process and many of the pigments lose their activity when heated. Many of the sensitive pigments are available in coated form, e.g. Carophyll® Pink, which is sold in the form of beadlets. The beadlets of this product consist of a core of astaxanthin emulsified in antioxidants and residing in a matrix of gelatine and carbohydrate, which core is coated by maize starch. The amount of astaxanthin is at least 8% of the beadlet. There is also another astaxanthin product of a similar kind that is called Carophyll® Pink 10% CWS, which differs from the first-mentioned product only in that the matrix is a lignosulfonate. If these beadlets are added as such to the preformed pellets, most of them are deposited only on the pellets' surface. Especially for aqua-cultural feed this is a disadvantage, since the beadlets will be washed away when the feed comes into contact with water. Also the bioavailability will be less when the pigments are still contained in the beadlets.

In EP 839 004-B1 a method is disclosed for loading bioactive ingredients, such as pigments, into feed pellets. The process includes the steps of removing the gelatin and carbohydrate protective shell around the bioactive ingredient enzymatically or by hydrolysis, mixing the uncoated bioactive ingredient with a fat or an oil and loading porous precursor feed pellets with the resulting mixture to produce the feed pellets.

In JP7-16075-A a method is described of making a water-soluble pigment solubilized in fat. Firstly polyols are dissolved in water and mixed with the water-soluble pigment, and then an oil-phase containing an emulsifier is added to obtain an emulsion of the water-soluble pigment in oil.

In JP7-23736-A a method is described of making a carotenoid pigment solubilized in water, where pH is made alkaline, cyclodextrins are mixed to the water and the pigment and finally the pH is restored to neutral.

EP 682 874-A2 discloses a bioactive feed pellet, where the bioactive ingredient could be for example a pigment. The bioactive ingredient is applied to the pellet in the form of a primary coating dispersion and/or emulsion and/or solution in a fatty component or a mixture of dietary oil, said component or dietary oil comprises a triglyceride and/or fatty acid thereof having a melting point of above 35° C. A second coating layer of an oily product is then applied. In case the bioactive compound to be added is not miscible with the suspending aid, a dispersing or emulsifying agent can be added to improve the mixing properties. Examples of such emulsifiers that are mentioned are distilled monoglycerides, polyunsaturated polyglycerol esters of fatty acids and sorbitan fatty acid esters; saturated monoglycerides are preferred.

From the references cited above, it is evident that the extraction of oil-soluble pigments from solid preparations, such as from the above-mentioned beadlets, needs further improvement.

Now it has surprisingly been found that when the extraction of a solid preparation, containing an oil-soluble pigment, with a hydrophobic extraction medium, such as an oil or a fat, is performed in the presence of water and a nonionic surfactant, the extraction and solubilization of the pigment are essentially improved.

In detail the process of the invention relates to a method for solubilizing an oil-soluble pigment into an oil or fat by extraction of a solid preparation containing the oil-soluble pigment comprising the steps of

a) mixing the solid preparation containing the pigment with water, an extraction medium containing an edible oil or fat, and a nonionic surfactant having a hydrocarbyl group, an acyl group or a substituted hydrocarbyl or acyl group containing at least 6 carbon atoms, and

b) optionally centrifugalize the mixture obtained and separate the oil phase

This method will lead to a more effective extraction of the pigment from the solid preparation and a more effective solubilization of the pigment into the oil or fat. The originally obtained mixture or the separated oil phase may then be added to porous precursor feed pellets to produce feed pellets. These pellets will have a higher amount of oil-soluble pigment available for uptake into the animal.

One embodiment of the process of the invention, where the solid pigment preparation is a coated pigment, such as a beadlet described above, comprises the following steps:

a) the coated pigment is agitated in water at a temperature between 4 and 100° C., and the edible oil or fat comprising the nonionic surfactant is added to the mixture obtained at a temperature of from the melting point of the oil or fat to 100° C. with agitation, or

the coated pigment and the nonionic surfactant are agitated in water at a temperature between 4 and 100° C., and the edible oil or fat is added with agitation to the pigment-surfactant mixture at a temperature of from the melting point of the oil or fat to 100° C.

b) optionally the mixture obtained is centrifugalized and the oil phase is separated

c) the mixture obtained by step a) or the separated oil phase obtained by step b) is added to porous precursor feed pellets to produce feed pellets.

There are several advantages using the method of the present invention. The method is more effective than the prior art methods in extracting and solubilizing the pigments, so that a larger proportion of the pigments will be extracted from the solid preparation and will be present in the oil phase. This is demonstrated in the examples, where the method of EP 839 004-B1 to enzymatically, in the presence of water, break down the gelatin and carbohydrate protective shell around the pigment to set it free from a solid preparation (beadlet) is compared to the method of the present invention where the addition of water and a nonionic surfactant more effectively sets the pigment free. Since the extraction and solubilization of the pigment are more effective, the method of the present invention will lead to a higher concentration of pigment in the oil. This will in turn lead to a larger proportion of pigment that is kept in the pellets that are loaded with this oil or fat. Further, the oil-phase is not so easily washed away as the untreated beadlets. Also, there will be a better bioavailability when the pigments are solubilized to a larger extent in the oil (see Bjerkeng, B. et al, Bioavailability of all-E-astaxanthin and Z-isomers of astaxanthin in rainbow trout (Oncorhynchus mykiss), Aquaculture 157, 63-82).

The dispersion or oil phase comprises an edible oil or fat, one or more oil-soluble pigments and one or more nonionic surfactants, and the invention also relates to such a composition suitable for use in loading pellets to be used as animal feed. A suitable composition would be an edible oil or fat comprising 0.25-15%, preferably 2-10% and most preferably 4-10% by weight of one or more nonionic surfactants, where the surfactant is an ester, an alkoxylate of an ester or an alkoxylate of an alcohol, preferably a castor oil ethoxylate with 2-40, preferably 2-25 and most preferably 4-20 moles of ethylene oxide, or a diacetyl tartaric acid ester of mono- and/or diglycerides; 0.0005 to 1% by weight, preferably 0.0005 to 0.3% by weight, more preferably 0.0005 to 0.2% by weight and most preferably 0.0005 to 0.1% by weight, of one or more oil-soluble pigments; and 0-20% by weight of other components including water. The other components could be vitamins, enzymes, anti-oxidants, residues from the beadlets' gelatine and carbohydrates, minerals, prophylactic agents, pharmacologically active compounds, flavouring agents, preservatives and other common feed additives. The water present in the composition is dissolved or emulsified in the oil by the surfactant, and would normally range between 0.1% and 15% by weight.

The edible oil or fat may be a fish-oil, such as menhaden oil, herring oil, sardine oil, tobis oil or capelin oil, hydrogenated fish-oil, castor oil, rapeseed oil, hydrogenated rapeseed oil, corn oil, soybean oil, hydrogenated soybean oil, sun flower oil, hydrogenated sun flower oil, olive oil, hydrogenated olive oil, palm oil, hydrogenated palm oil, coconut oil, hydrogenated coconut oil, tallow or lard. Hydrogenated oil is normally needed when the total amount of oil or fat is high, such as for total amounts of oil or fat in fish-feed of 26% (w/w) or higher (counted on the total pellet weight). The amount hydrogenated oil or fat that is present in these pellets is normally between 0.2 to 10% (w/w) of the total amount of oil or fat.

The pigment is preferably a carotenoid, which could belong to either of the sub-groups carotenes or xanthophylls. Suitable xanthophylls are lutein, zeaxanthin, canthaxanthin, astaxanthin or β-cryptoxanthin, and suitable carotenes are β-carotene, alfa-carotene and lycopene. Examples of commercial products containing these pigments are Carophyll® Pink (Hoffman LaRoche; min 8% (w/w) astaxanthin), Lucantin® Pink (BASF; min 10% (w/w) astaxanthin), Lucarotin® 10% Feed (BASF; min 10% (w/w) β-carotene), Lucantin® Red (BASF; min 10% canthaxanthin) and Rovimix (Hoffman LaRoche; min 10% (w/w) β-carotene).

The surfactant should be a nonionic surfactant, such as an ester, an alkoxylate of an ester or an alkoxylate of an alcohol. Preferred nonionic surfactants are sorbitan esters, ethoxylated sorbitan esters, tartaric acid esters of mono- and diglycerides, alkoxylated fats, oils or other esters, and alkoxylated alcohols. The most preferred nonionic surfactants are castor oil ethoxylates, preferably castor oil ethoxylates with 2-40 moles, more preferably with 2-25 moles, and most preferably with 4-20 moles of ethylene oxide per mol castor oil. Experiments have also been made to use an ionic surfactant, such as a native lecithin, but the results were not as good as when using a nonionic surfactant. Certain nonionics perform better with certain pigments. For example, castor oil ethoxylates are especially suited to be used for the solubilization of astaxanthin and canthaxanthin, whereas diacetyl tartaric acid esters of mono- and diglycerides are especially suited for the solubilization of β-carotene. A comparison between some castor oil ethoxylates with different amounts of ethylene oxide, and consequently different HLB-values, and the corresponding mixtures of sorbitan monooleate +20EO and sorbitan monooleate having the same HLB-values show that the castor oil ethoxylates having up to 25 moles of ethylene oxide are much more efficient in solubilizing astaxanthin.

The porous precursor feed pellets could be manufactured by any known method, e.g. extrusion, and from any commonly used material, such as carbohydrates or protein. When loading the precursor feed pellets, the temperature should be high enough to keep the fat or oil in a liquid state, but not above the decomposition temperature of the pigment. A suitable temperature is between the melting point of the fat or oil and 60° C. The loading of the feed pellets with the pigment-containing oil could be performed by mixing, dipping, spraying, coating or other commonly used means.

A suitable pellet composition, obtained by loading precursor feed pellets with the above-mentioned oil or fat composition, has an amount of oil between 1 and 50%, preferably between 3 and 45% and most preferably between 5 and 40%, by weight of the loaded feed pellets.

The present invention is further illustrated by the following Examples.

### EXAMPLE 1

10% (w/w) of Carophyll® Pink¹ was mixed with 90% (w/w) water at a temperature of 60° C. with stirring. After cooling to room temperature a formulation was made containing 7.5% (w/w) of the mixture and 92.5% (w/w) of a surfactant/fish-oil mixture (sample type A), the formulation was stirred for 2 minutes at a temperature of ca 45° C. and the next day it was centrifugalized at 5000 rpm (G=34000 m/s²) for 5 minutes. A sample was taken with a syringe and filtered through a 0.2 μm micropore filter. If the sample was taken after a few days it was not necessary to centrifugalize the formulation, but the sample could be taken directly from the oil-phase and filtered. The sample was then diluted with acetone to a desired concentration, and the absorbance was measured at 474 nm. In Table 1 the absorbance values for different samples are displayed, which is a measure of the abilities of the different surfactants to solubilize the pigment astaxanthin. The formulation could also be made by first mixing the surfactant with the pigment/water mixture, and then mix with the fish-oil (sample type B).

| | Pigment/ | Castor | Castor | Castor | Castor | Castor | | | Absorbance at |
|---|---|---|---|---|---|---|---|---|---|
| Sample | Water | oil | oil | oil | oil | oil | Fish-oil | Absorbance at | 474 nm² after |
| Type | mix (g) | +6EO | +12EO | +20EO | +28EO | +40EO | Tobis | 474 nm² | 11 days |
| Control | 3 | | | | | | 37 | 0.11 | 0.38 |
| A | 3 | 3 | | | | | 34 | 1.01 | 3.4 |
| A | 3 | | 3 | | | | 34 | 0.73 | 1.8 |
| A | 3 | | | | 3 | | 34 | 1.09 | 1.6 |
| A | 3 | | | | | 3 | 34 | 0.50 | — |
| B | 3 | 3 | | | | | 34 | 1.14 | 3.4 |
| B | 3 | | 3 | | | | 34 | 0.81 | 0.96 |
| B | 3 | | | 3 | | | 34 | 0.49 | — |
| B | 3 | | | | 3 | | 34 | 0.70 | — |
| B | 3 | | | | | 3 | 34 | 0.88 | — |

¹Carophyll ® Pink is a product produced by Hoffman LaRoche that contains at least 8% (w/w) of the pigment astaxanthin
²0.400 ml of the oil-phase was diluted with acetone to 10 ml

The solubilization of the pigment was much more effective when a nonionic surfactant was added to the formulation than for the control formulation where no surfactant was added.

### EXAMPLE 2

The pigment used in this example was Carophyll® Pink. The procedure followed was the same as for Example 1.

The recovery values are based on the assumption that the product Carophyll® Pink contains 8% astaxanthin, which is the amount astaxanthin that the producer guarantees is present.

| | | | | | Absorb- | Absorbance |
|---|---|---|---|---|---|---|
| | | Castor | Castor | Fish- | ance | at 474 nm |
| | Pigment/ | oil | oil | oil | at 474 nm | after 13 |
| Sample | water mix | +6EO | +28EO | Tobis | after | days⁴ (% |
| Type | (g) | (g) | (g) | (g) | 1 day³ | recovery) |
| Control | 3 | | | 37 | 0.05 | 0.02 |
| | | | | | | (4.4) |
| A | 3 | 3 | | 34 | 1.48 | 0.33 |
| | | | | | | (72.6) |
| A | 3 | 1.5 | | 35.5 | 1.52 | 0.3 |
| | | | | | | (66.3) |
| A | 3 | 6 | | 31 | 1.16 | 0.2 |
| | | | | | | (43.7) |
| A | 3 | 9 | | 28 | 1.66 | 0.22 |
| | | | | | | (47.6) |
| A | 3 | | 3 | 34 | 1.02 | 0.2 |
| | | | | | | (44.0) |
| A | 3 | | 6 | 31 | 0.98 | 0.19 |
| | | | | | | (41.5) |

³0.200 ml of the oil-phase was diluted with acetone to 10 ml
⁴0.400 ml of the oil-phase was diluted with acetone to 100 ml

The amount of surfactant is not very critical within the investigated range.

| | | | | | Absorbance | Ab- |
|---|---|---|---|---|---|---|
| | | Castor | | | at 474 nm | sorbance |
| Sam- | Pigment/ | oil | Castor | Fish-oil | after 1 day⁵ | at 474 nm |
| ple | water mix | +6EO | oil | Tobis | (% | after 23 |
| Type | (g) | (g) | (g) | (g) | recovery) | days⁶ |
| A | 3 | | 3 | 34 | 0.11 | — |
| A | 3 | 3 | | 34 | 1.24* | 0.41 |
| | | | | | (54.6) | (72.2) |
| A | 3 | 1.5 | | 35.5 | 1.28* | 0.33 |
| | | | | | (56.6) | (58.3) |
| A | 3 | 0.75 | | 36.25 | 0.57 | 0.14 |
| | | | | | (25.2) | (24.8) |
| A | 3 | 0.375 | | 36.625 | 0.14 | 0.05 |
| | | | | | (6.2) | (8.9) |
| A | 1.5 | 3 | | 35.5 | 0.72 | 0.22 |
| | | | | | (66.0) | (80.6) |

⁵0.200 ml of the oil-phase was diluted with acetone to 10 ml
⁶0.500 ml of the oil-phase was diluted with acetone to 100 ml
*for an absorbance value of >0.9 there is not a linear relationship between absorbance and concentration

Within this range there is a correlation between the amount of surfactant used and the amount of pigment solubilized.

### EXAMPLE 3

In this experiment the amount of pigment to be solubilized is varied from ca 25 ppm, counted on the whole mixture, up to 750 ppm, and the amount of surfactant (castor oil +6EO) used is also varied.

5-10% (w/w) of Lucantin® Pink CWD was mixed with 95-90% (w/w) of water at room temperature with stirring. A formulation was made containing ca 0.5-7.5% (w/w) of the mixture and ca 99.5-92.5% (w/w) of the surfactant/fish-oil mixture. The formulation was stirred for 2 minutes at a temperature of 45° C. and then centrifugalized at 5000 rpm for 5 minutes. The sample was filtered through a 0.2 μm micropore filter and 0.400 ml of the filtrate was diluted with acetone to 100 ml.

| | Weight | | | | | |
|---|---|---|---|---|---|---|
| | ratio | Pigment/ | Pigment | Castor oil | Fish-oil | Absorbance |
| Sample | surfactant/ | water mix | concentration | +6EO | Tobis | at 474 nm^{a} |
| Type | oil | (g) | (ppm) | (g) | (g) | (% recovery)^{c} |
| Control | | 0 | 0 | 0 | 37 | 0.015 |
| Only oil | 0/100 | 0.19 | 26 | 0 | 37 | 0.031^{a} |
| A | 2/98 | 0.18 | 24 | 0.75 | 36.25 | 0.032^{a} |
| | | | | | | (102.2) |
| A | 8/92 | 0.17 | 23 | 3 | 34 | 0.029^{a} |
| | | | | | | (94.5) |
| A | 16/84 | 0.18 | 24 | 6 | 31 | 0.032^{a} |
| | | | | | | (113.0) |
| Only oil | 0/100 | 0.5 | 133 | 0 | 37 | 0.015^{b} |
| | | | | | | (0%) |
| A | 2/98 | 0.51 | 136 | 0.75 | 36.25 | 0.107^{b} |
| | | | | | | (96.2) |
| A | 8/92 | 0.5 | 133 | 3 | 34 | 0.107^{b} |
| | | | | | | (98.5) |
| A | 16/84 | 0.5 | 133 | 6 | 31 | 0.098^{b} |
| | | | | | | (89.5) |
| Control | | 0 | 0 | 0 | 37 | 0.013 |
| Only oil | 0/100 | 2.432 | 750 | 0 | 30 | 0.018^{a} |
| | | | | | | (0.9) |
| A | 2/98 | 3 | 750 | 0.75 | 36.25 | 0.103^{a} |
| | | | | | | (16.0) |
| A | 8/92 | 3 | 750 | 3 | 34 | 0.515^{a} |
| | | | | | | (88.6) |
| A | 16/84 | 3 | 750 | 6 | 31 | 0.479^{a} |
| | | | | | | (81.8) |

^{a}after 4 days in refrigerator
^{b}direct measurement
The absorbance values have been corrected for the absorbance of the oil itself, without added pigment.
^{c}The recovery values are based on the assumption that the product Lucantin ® Pink CWD contains 10% astaxanthin, which is the amount astaxanthin that the producer guarantees is present.

This experiment shows that for the amounts 23-136 ppm of pigment, the whole amount is easily solubilized even at the low weight ratio of 2/98 of surfactant to oil, whereas for the higher amount of 750 ppm a higher weight ratio is required. However, a weight ratio above 8/92 does not result in any increase of the amount of pigment solubilized.

### EXAMPLE 4

The procedure followed was the same as for Example 1.

| | | | | | Absorbance |
|---|---|---|---|---|---|
| | | | | | at 474 nm |
| | | Pigment/ | | | after 1 day in |
| | | water | Castor oil | Fish-oil | refrigerator and |
| Sample | | mix | +6EO | Tobis | filtration⁴ |
| type | Pigment | (g) | (g) | (g) | (% recovery) |
| Control | Lucantin ® | 3 | | 37 | 0.018 |
| | Pink | | | | (3.2) |
| | CWD | | | | |
| A | Lucantin ® | 3 | 3 | 34 | 0.522 |
| | Pink | | | | (91.9) |
| | CWD | | | | |
| A | Lucantin ® | 2 | 3 | 34 | 0.362 |
| | Pink | | | | (95.6) |
| | CWD | | | | |
| A | Lucantin ® | 1 | 3 | 34 | 0.164 |
| | Pink | | | | (86.6) |
| | CWD | | | | |
| A | Lucantin ® | 0.5 | 3 | 34 | 0.107 |
| | Pink | | | | (113.1) |
| | CWD | | | | |
| A | Lucantin ® | 0.25 | 3 | 34 | 0.063 |
| | Pink | | | | (133.1) |
| | CWD | | | | |

⁴0.400 ml of the oil-phase was diluted with acetone to 100 ml

Lucantin® Pink CWD is a product produced by BASF that contains at least 10% (w/w) of the pigment astaxanthin. The recovery values are based on this amount of pigment in the product.

### EXAMPLE 5

In this example the castor oil ethoxylates are compared to other kinds of surfactants. The pigment used was Carophyll® Pink. The procedure followed was the same as for Example 1.

| | | | | | | Sorbitan | | |
|---|---|---|---|---|---|---|---|---|
| | | Castor | | Sterncithin | Sorbitan | ester | | Absorbance |
| | Pigment | oil | Castor oil | F 10 | ester | monooleate | Fish-oil | at 474 nm |
| Sample | water mix | +6EO | +12EO | (a lecithin) | monooleate | +20EO | Tobis | after 1 day⁷ |
| Type | (g) | (g) | (g) | (g) | (g) | (g) | (g) | (% recovery) |
| A | 3 | 3 | | | | | 34 | 1.24 |
| | | | | | | | | (54.6) |
| A | 3 | | 3 | | | | 34 | 0.85 |
| | | | | | | | | (37.4) |
| A | 3 | | | 3 | | | 34 | 0.09 |
| | | | | | | | | (4.0) |
| A | 3 | | | 6 | | | 31 | 0.11 |
| | | | | | | | | (4.8) |
| A | 3 | | | | 3 | | 34 | 0.38 |
| | | | | | | | | (16.7) |
| A | 3 | | | | | 3 | 34 | 0.25 |
| | | | | | | | | (11.0) |
| B | 3 | | | | | 3 | 34 | 0.98 |
| | | | | | | | | (43.1) |

⁷0.200 ml of the oil-phase was diluted with acetone to 10 ml

In this test the castor oil ethoxylates had the best effect, but also the sorbitan ester and the ethoxylate thereof are able to aid in the solubilization of the pigment astaxanthin. The lecithin only had a minor effect.

### EXAMPLE 6

In this example the effect of HLB-values on the solubilizing ability is investigated for castor oil ethoxylates and for Tween 80⁸/Span 80⁹ mixtures having the same HLB-values as the castor oil ethoxylates. The pigment used was Lucantin® Pink CWD and the oil was Tobis fish-oil. The procedure was the same as in Example 1 except that the pigment was mixed and stirred with the water at room temperature. All samples were of type A. The formulations contained 2 g of the specific surfactant or surfactant mixture, and the weight ratio surfactant:fish-oil was 6:94. The amount of pigment/water mix was 2.57 g.

| | | Absorbance at | | Absorbance at |
|---|---|---|---|---|
| | Castor oil | 474 nm¹⁰ for | | 474 nm¹⁰ for the |
| | ethoxylate | the castor oil | Tween80/Span80 | Tween80/Span80 |
| HLB- | number of | ethoxylates | mixtures | mixtures |
| value | EO units | (% recovery) | (g/g) | (% recovery) |
| 5.9 | 6 | 0.464 | 0.3/1.7 | 0.109 |
| | | (82.6) | | (19.2) |
| 9.4 | 15 | 0.498 | 0.954/1.046 | 0.167 |
| | | (88.7) | | (29.7) |
| 10.5 | 20 | 0.424 | 1.196/0.804 | 0.218 |
| | | (75.5) | | (38.8) |
| 11.8 | 25 | 0.261 | 1.384/0.616 | 0.244 |
| | | (46.5) | | (43.5) |
| 13.3 | 36 | 0.17 | 1.682/0.318 | 0.218 |
| | | (30.3) | | (38.8) |

⁸Tween 80 is sorbitan monooleate +20EO
⁹Span 80 is sorbitan monooleate
¹⁰0.200 ml of the filtered oil-phase was diluted with acetone to 10 ml.

The samples were then further diluted by taking 2.00 ml of the acetone solution and dilute it to 10 ml.

For the castor oil ethoxylates there is a marked decline in the solubilizing ability around a HLB-value of 11, whereas for the Tween 80/Span 80 mixtures the level is about the same for all mixtures and generally lower than for the castor oil ethoxylates. However, both types of compounds have an effect on the solubilization of the pigment astaxanthin.

### EXAMPLE 7

All samples in this experiment were of type A. Tests were made with two products containing astaxanthin and one product containing canthaxanthin. The samples were prepared by the same procedure as described in Example 1, except that Carophyll® Pink CWS and Lucantin® Red CWD were mixed and stirred with the water at room temperature.

| | | | | | | | Absorbance at | |
|---|---|---|---|---|---|---|---|---|
| | Pigment | Castor oil | Castor oil | DATEM | Sorbitan | Rapeseed | 474 nm after 3 | Absorbance at |
| | water mix | +5.3EO | +6EO | emulsifier¹¹ | monooleate | oil | days¹⁵ | 470 nm after 3 |
| Pigment | (g) | (g) | (g) | (g) | +20EO (g) | (g) | (% recov.) | days¹⁵ |
| Carophyll ® | 2.57 | 2 | | | | 30 | 0.479 | |
| Pink | | | | | | | (85.3) | |
| CWS¹² | | | | | | | | |
| Carophyll ® | 2.57 | | 2 | | | 30 | 0.446 | |
| Pink CWS | | | | | | | (79.4) | |
| Carophyll ® | 2.57 | | | 2 | | 30 | 0.504 | |
| Pink CWS | | | | | | | (89.8) | |
| Carophyll ® | 2.57 | | | | 2 | 30 | 0.325 | |
| Pink CWS | | | | | | | (57.9) | |
| Lucantin ® | 2.57 | | 2 | | | 30 | | 0.616 |
| Red | | | | | | | | |
| CWD¹³ | | | | | | | | |
| Lucantin ® | 2.57 | | | 2 | | 30 | | 0.497 |
| Red CWD | | | | | | | | |
| Lucantin ® | 2.57 | | | | 2 | 30 | | 0.12 |
| Red CWD | | | | | | | | |
| Lucantin ® | 2.57 | | 2 | | | 30 | 0.681 | |
| Pink¹⁴ | | | | | | | (121.3)* | |
| Lucantin ® | 2.57 | | | 2 | | 30 | 0.32 | |
| Pink | | | | | | | (57.0) | |
| Lucantin ® | 2.57 | | | | 2 | 30 | 0.094 | |
| Pink | | | | | | | (16.7) | |

¹¹DATEM emulsifier = Diacetyl tartaric acid esters of mono- and diglycerides
¹²Carophyll ® Pink CWS (Hoffman LaRoche; min 10% (w/w) astaxanthin; cold water dispersible)
¹³Lucantin ® Red CWD (BASF; min 10% canthaxanthin; cold water dispersible)
¹⁴Lucantin ® Pink (BASF; min 10% (w/w) astaxanthin)
¹⁵The samples were stored in a refrigerator. 0.200 ml of the oil-phase was diluted with acetone to 10 ml.
*This value is based on the assumption that the product Lucantin ® Pink contains 10% astaxanthin, which is the amount astaxanthin that the producer guarantees is present.

### EXAMPLE 8

All samples in this experiment were of type A. Tests were made with one product containing β-carotene, one containing canthaxanthin and one containing astaxanthin. The samples were prepared by the same procedure as described in Example 1, except that Lucantin® Pink CWD and Lucantin® Red CWD were mixed and stirred with the water at room temperature.

| | Pigment | Castor oil | Castor oil | Castor oil | Castor oil | DATEM | Rapeseed | Absorbance at |
|---|---|---|---|---|---|---|---|---|
| | water mix | +6EO | +15EO | +20EO | +25EO | emulsifier | oil | 450 nm¹⁷ after 1 |
| Pigment | (g) | (g) | (g) | (g) | (g) | (g) | (g) | day in refrigerator |
| Lucarotin ® | 2.57 | | | | | | 32 | 0 |
| 10% Feed¹⁶ | | | | | | | | |
| Lucarotin ® | 2.57 | 2 | | | | | 30 | 0.125 |
| 10% Feed | | | | | | | | |
| Lucarotin ® | 2.57 | | 2 | | | | 30 | 0.077 |
| 10% Feed | | | | | | | | |
| Lucarotin ® | 2.57 | | | 2 | | | 30 | 0.081 |
| 10% Feed | | | | | | | | |
| Lucarotin ® | 2.57 | | | | 2 | | 30 | 0.074 |
| 10% Feed | | | | | | | | |
| Lucarotin ® | 2.57 | | | | | 2 | 30 | 0.648 |
| 10% Feed | | | | | | | | |

¹⁶Lucarotin ® 10% feed (BASF; min 10% (w/w) β-carotene)
¹⁷0.200 ml of the oil-phase was diluted with acetone to 10 ml. The samples were then further diluted by taking 2.00 ml of the acetone solution and dilute it to 10 ml.

For Lucarotin® 10% Feed (β-carotene) DATEM emulsifier (diacetyl tartaric acid esters of mono- and diglycerides) is especially good as a solubilizer.

In this experiment soybean oil and rapeseed oil were tested as the oil components when solubilizing the pigment astaxanthin.

| | Pigment | | | | | | | Absorbance at 474 nm¹⁹ |
|---|---|---|---|---|---|---|---|---|
| | water | Castor oil | Castor oil | Castor oil | Castor oil | Soybean | Rapeseed | after 1 day in |
| | mix | +4EO | +6EO | +15EO | +20EO | oil | oil | refrigerator |
| Pigment | (g) | (g) | (g) | (g) | (g) | (g) | (g) | (% recov.) |
| Lucantin ® | 2.57 | | | | | 32 | 0 | |
| Pink | | | | | | | | |
| CWD | | | | | | | | |
| Lucantin ® | 2.57 | 2 | | | | 30 | | 0.534 |
| Pink | | | | | | | | (95.1) |
| CWD | | | | | | | | |
| Lucantin ® | 2.57 | | 2 | | | 30 | | 0.498 |
| Pink | | | | | | | | (88.7) |
| CWD | | | | | | | | |
| Lucantin ® | 2.57 | | | 2 | | 30 | | 0.42 |
| Pink | | | | | | | | (74.8) |
| CWD | | | | | | | | |
| Lucantin ® | 2.57 | | | | 2 | 30 | | 0.232 |
| Pink | | | | | | | | (41.3) |
| CWD | | | | | | | | |
| Lucantin ® | 2.57 | | | | | | 32 | 0.021 |
| Pink | | | | | | | | (3.8) |
| CWD | | | | | | | | |
| Lucantin ® | 2.57 | | 2 | | | | 30 | 0.5 |
| Pink | | | | | | | | (89.0) |
| CWD | | | | | | | | |
| Lucantin ® | 2.62 | | | 2 | | | 30 | 0.38 |
| Pink | | | | | | | | (66.4) |
| CWD | | | | | | | | |
| Lucantin ® | 2.57 | | | | 2 | | 30 | 0.182 |
| Pink | | | | | | | | (32.4) |
| CWD | | | | | | | | |

¹⁹0.200 ml of the oil-phase was diluted with acetone to 10 ml. The samples were then further diluted by taking 2.00 ml of the acetone solution and dilute it to 10 ml.

For the solubilization of Lucantin® Pink CWD (astaxanthin) there is not a big difference between the samples containing soybean oil as compared to the samples containing rapeseed oil.

### EXAMPLE 9

The samples were prepared by the same procedure as described in Example 1, except that Lucantin® Pink CWD and Lucantin® Red CWD were mixed and stirred with the water at room temperature. All samples were of type A.

| | | | | C₁₁- | | | | |
|---|---|---|---|---|---|---|---|---|
| | Pigment | Castor | Castor | alcohol | Nonyl-phenol | Sorbitan | Fish-oil | Absorbance at 474 nm²⁰ |
| | water | oil | oil | +2EO | +4EO | monooleate | (blue | After 8 days in |
| | mix | +6EO | +15EO | HLB 6.8 | HLB 8.9 | +20EO | whiting) | refrigerator and filtration |
| Pigment | (g) | (g) | (g) | (g) | (g) | (g) | (g) | (% recov.) |
| Lucantin ® Pink | 3 | 2 | | | | | 35 | 0.473 |
| CWD | | | | | | | | (83.5) |
| Lucantin ® Pink | 3 | | 2 | | | | 35 | 0.519 |
| CWD | | | | | | | | (91.6) |
| Lucantin ® Pink | 3 | | | 2 | | | 35 | 0.335 |
| CWD | | | | | | | | (59.1) |
| Lucantin ® Pink | 3 | | | | 2 | | 35 | 0.227 |
| CWD | | | | | | | | (40.1) |
| Lucantin ® Pink | 3 | | | | | 2 | 35 | 0.43 |
| CWD | | | | | | | | (75.9) |

²⁰0.200 ml of the oil-phase was diluted with acetone to 10 ml
The samples were then further diluted by taking 2.00 ml of the acetone solution and dilute it to 10 ml

The recovery of the amount of the pigment astaxanthin present in the beadlets is very high when using the castor oil ethoxylates. Also when using sorbitan monooleate +20EO, the recovery is good for this pigment.

In this experiment a number of emulsifiers were tested for the solubilization of the pigment canthaxanthin.

| | | | | C₁₁- | | | | | Absorbance at |
|---|---|---|---|---|---|---|---|---|---|
| | Pigment | Castor | Castor | alcohol + | Nonylphenol + | | Sorbitan | Fish-oil | 470 nm²¹ After |
| | water | oil + | oil + | 2EO | 4EO | Polyglycerol | monooleate + | (blue | 8 days in |
| | mix | 6EO | 15EO | HLB 6.8 | HLB 8.9 | polyricinoleate | 20EO | whiting) | refrigerator |
| Pigment | (g) | (g) | (g) | (g) | (g) | (g) | (g) | (g) | and filtration |
| Lucantin ® | 3 | 2 | | | | | | 35 | 0.597 |
| Red | | | | | | | | | |
| CWD | | | | | | | | | |
| Lucantin ® | 3 | | 2 | | | | | 35 | 0.613 |
| Red | | | | | | | | | |
| CWD | | | | | | | | | |
| Lucantin ® | 3 | | | 2 | | | | 35 | 0.41 |
| Red | | | | | | | | | |
| CWD | | | | | | | | | |
| Lucantin ® | 3 | | | | 2 | | | 35 | 0.218 |
| Red | | | | | | | | | |
| CWD | | | | | | | | | |
| Lucantin ® | 3 | | | | | 2 | | 35 | 0.077 |
| Red | | | | | | | | | |
| CWD | | | | | | | | | |
| Lucantin ® | 3 | | | | | | 2 | 35 | 0.352 |
| Red | | | | | | | | | |
| CWD | | | | | | | | | |

²¹0.200 ml of the oil-phase was diluted with acetone to 10 ml

The samples were then further diluted by taking 2.00 ml of the acetone solution and dilute it to 10 ml. The filtration was performed using a 0.45 μm filter.

In this experiment a number of emulsifiers were tested for the solubilization of the pigment β-carotene.

| | | | | C₁₁- | | | | |
|---|---|---|---|---|---|---|---|---|
| | Pigment | Castor | Castor | alcohol + | | Sorbitan | Fish-oil | |
| | water | oil + | oil + | 2EO | Polyglycerol | monooleate + | (blue | Absorbance at 450 nm²² |
| | mix | 6EO | 15EO | HLB 6.8 | polyricinoleate | 20EO | whiting) | After 8 days in |
| Pigment | (g) | (g) | (g) | (g) | (g) | (g) | (g) | refrigerator and filtration |
| Lucarotin ® | 3 | 2 | | | | | 35 | 0.406 |
| 10% Feed | | | | | | | | |
| Lucarotin ® | 3.08 | | 2 | | | | 35 | 0.212 |
| 10% Feed | | | | | | | | |
| Lucarotin ® | 3 | | | 2 | | | 35 | 0.562 |
| 10% Feed | | | | | | | | |
| Lucarotin ® | 3 | | | | 2 | | 35 | 0.097 |
| 10% Feed | | | | | | | | |
| Lucarotin ® | 3 | | | | | 2 | 35 | 0.135 |
| 10% Feed | | | | | | | | |

²²0.200 ml of the oil-phase was diluted with acetone to 10 ml. The filtration was performed using a 0.45 μm filter.

In this experiment a number of emulsifiers were tested for the solubilization of the pigment astaxanthin.

| | Pigment | | | | | Sorbitan | | Absorbance at 474 nm²³ |
|---|---|---|---|---|---|---|---|---|
| | water | Castor oil + | Castor oil + | Sorbitan | Sorbitan | monooleate + | Tobis | after 1.5 days in |
| | mix | 6EO | 15EO | monooleate | monostearate | 20EO | fish-oil | refrigerator and filtration |
| Pigment | (g) | (g) | (g) | (g) | (g) | (g) | (g) | (% recov.) |
| Lucantin ® | 3 | | | | | | 37 | 0.023 |
| Pink | | | | | | | | (4.1) |
| CWD | | | | | | | | |
| Lucantin ® | 3 | 2 | | | | | 35 | 0.41 |
| Pink | | | | | | | | (72.4) |
| CWD | | | | | | | | |
| Lucantin ® | 3 | | 2.04 | | | | 35 | 0.427 |
| Pink | | | | | | | | (75.5) |
| CWD | | | | | | | | |
| Lucantin ® | 3.03 | | | 2 | | | 35 | 0.157 |
| Pink | | | | | | | | (27.4) |
| CWD | | | | | | | | |
| Lucantin ® | 3 | | | | 2 | | 35 | 0.174 |
| Pink | | | | | | | | (30.7) |
| CWD | | | | | | | | |
| Lucantin ® | 3 | | | | | 2 | 35 | 0.302 |
| Pink | | | | | | | | (53.3) |
| CWD | | | | | | | | |

²³0.200 ml of the oil-phase was diluted with acetone to 10 ml.

### EXAMPLE 10

The samples were prepared by the same procedure as described in Example 1, except that Lucantin Pink® CWD was mixed and stirred with the water at room temperature.

| | | | Castor | Castor | Castor | Castor | | Absorbance at 474 nm |
|---|---|---|---|---|---|---|---|---|
| | | Pigment/ | oil + | oil + | oil + | oil + | Fish-oil | after 1 day in |
| Sample | | water mix | 2EO | 4EO | 6EO | 10EO | Tobis | refrigerator and filtration |
| type | Pigment | (g) | (g) | (g) | (g) | (g) | (g) | (% recovery) |
| Control | Lucantin ® | 3 | | | | | 37 | 0.018 |
| | Pink CWD | | | | | | | (3.2) |
| A | Lucantin ® | 3 | 3 | | | | 34 | 0.514 |
| | Pink CWD | | | | | | | (90.5) |
| A | Lucantin ® | 3 | | 3 | | | 34 | 0.504 |
| | Pink CWD | | | | | | | (88.7) |
| A | Lucantin ® | 3 | | | 3 | | 34 | 0.522 |
| | Pink CWD | | | | | | | (91.9) |
| A | Lucantin ® | 3 | | | | 3 | 34 | 0.507 |
| | Pink CWD | | | | | | | (89.3) |

This example shows that the solubilizing efficiency of castor oil ethoxylates with 2-10 moles of EO per mole castor oil is very good and about equal for all the products investigated.

### EXAMPLE 11

In this example a comparison is made with the enzymatic method described in the prior art. The procedure for the enzymatic method was the following:

10% (w/w) of Lucantin® Pink was mixed with water, that was buffered to pH 7.5 and that contained 0.5 mg/ml protease (Protease Streptomyces griseus; CAS number 9036-06-0, 5.6 units/mg solid powder), at a temperature of 55° C. with stirring. The pigment/water/enzyme mixture was then stirred at 45° C. for 90 minutes. After cooling to room temperature a formulation was made containing 7.4% (w/w) of the mixture and 92.6% (w/w) of fish-oil, the formulation was stirred for 2 minutes at a temperature of ca 45° C. and the next day it was centrifugalized at 5000 rpm (G=34000 m/s²) for 5 minutes. A sample was taken with a syringe and filtered through a 0.2 μm micropore filter. 0.400 ml of the filtrated sample was then diluted with acetone to 100 ml, and the absorbance was measured at 474 nm. The sample according to the invention was treated in the same manner, except that it contained no protease and the formulation was made by mixing with 92.6% (w/w) of castor oil +6EO/fish-oil mixture. In Table below the absorbance values for the different samples are displayed, which is a measure of the abilities of the different methods to solubilize the pigment astaxanthin.

| | | | | | Absorbance |
|---|---|---|---|---|---|
| | | Pigment/ | Castor | Fish | at 474 nm |
| | | water | oil + | oil | after 2 days |
| Sample | | mix | 6EO | Tobis | in refrigerator |
| Type | Pigment | (g) | (g) | (g) | and filtration |
| Control | Lucantin ® | 3 | | 37 | 0.025 |
| | Pink | | | | |
| A | Lucantin ® | 3 | 2 | 35 | 0.589 |
| | Pink | | | | |
| Comparison | Lucantin ® | 3 | | 37 | 0.099 |
| (protease²⁴) | Pink | | | | |

²⁴The protease is active at temperatures between 25 to 70° C. and at pH-values between 7.0 and 10.0.

The comparison reveals that much more astaxanthin can be solubilized by using the method of the present invention than by using the enzymatic procedure disclosed in the prior art.

### EXAMPLE 12

This example is also a comparison with the enzymatic method described in the prior art. The procedure was the same as in Example 11, except that the water was buffered at pH 9.5 and contained 1.0 mg/ml or 0.35 mg/ml of a protease (Protex 6L produced by Genencor International; activity 580000 DU/g)

| | | | | | Absorbance |
|---|---|---|---|---|---|
| | | Pigment/ | Castor | Fish | at 474 nm |
| | | water | oil + | oil | after 3 days |
| Sample | | mix | 6EO | Tobis | in refrigerator |
| Type | Pigment | (g) | (g) | (g) | and filtration |
| A | Lucantin ® | 3 | 2 | 35 | 0.603 |
| | Pink | | | | |
| Comparison | Lucantin ® | 3 | | 37 | 0.016 |
| (protease²⁴ | Pink | | | | |
| 0.35 mg/ml) | | | | | |
| Comparison | Lucantin ® | 3 | | 37 | 0.046 |
| (protease²⁴ | Pink | | | | |
| 1.0 mg/ml) | | | | | |
| A + protease | Lucantin ® | 3 | 2 | 35 | 0.567 |
| (1.0 mg/ml) | Pink | | | | |

²⁴The protease is active at temperatures between 25 to 70° C. and at pH-values between 7.0 and 10.0.

The comparison reveals that also during these conditions with a higher pH, a different protease and a higher concentration of the protease, much more astaxanthin can be solubilized by using the method of the present invention than by using the enzymatic procedure disclosed in the prior art.

1. A method for solubilizing an oil-soluble pigment into an oil or fat by extraction of a solid preparation containing the oil-soluble pigment, comprising the steps of
a) mixing the solid preparation containing the pigment with water, an extraction medium containing an edible oil or fat, and a nonionic surfactant having a hydrocarbyl group, an acyl group or a substituted hydrocarbyl or acyl group containing at least 6 carbon atoms
b) optionally centrifugalize the mixture obtained and separate the oil phase

2. A method according to claim 1 where the solid preparation containing the pigment is a coated pigment and
a) the coated pigment is agitated in water at a temperature between 4 and 100° C., and the edible oil or fat comprising the nonionic surfactant is added to the mixture obtained at a temperature of from the melting point of the oil or fat to 100° C. with agitation,
or the coated pigment and the nonionic surfactant are agitated in water at a temperature between 4 and 100° C., and the edible oil or fat is added with agitation to the pigment-surfactant mixture at a temperature of from the melting point of the oil or fat to 100° C.

3. The method of claim 1 where the nonionic surfactant is an ester, an alkoxylate of an ester or an alkoxylate of an alcohol.

4. A method according to claim 3 where the surfactant is a castor oil ethoxylate with 2-25 moles of ethylene oxide or a diacetyl tartaric acid ester of mono- and/or diglycerides.

5. The method of claim 1 where the pigment is a carotenoid.

6. The method of claim 1 where the pigment is selected from the group astaxanthin, canthaxanthin and β-carotene.

7. An edible oil or fat composition comprising 0.25-15% by weight of one or more nonionic surfactants in accordance with claim 1, 0.0005 to 1% by weight of one or more oil-soluble pigments, and 0-20% by weight of other components including water.

8. A composition according to claim 7 where the pigment is a carotenoid.

9. The composition of claim 7 where the oil is selected from the group castor oil, a fish-oil, rapeseed oil, corn oil and soybean oil.

10. A method for producing feed pellets by adding the solubilized oil-soluble pigment obtained in claim 1 to porous precursor feed pellets.

11. A solubilizer for an oil-soluble pigment in an edible oil, said solubilizer comprising a nonionic surfactant having a hydrocarbyl group, an acyl group or a substituted hydrocarbyl or acyl group containing at least 6 carbon atoms.

12. The solubilizer of claim 11, where the surfactant is a castor oil ethoxylate with 2-25 moles of ethylene oxide or a diacetyl tartaric acid ester of mono- and/or diglycerides.

13. Animal feed pellets comprising the solubilizer of claim 11.

14. A pellet composition characterized in that it has been obtained by loading a composition according to claim 7 to precursor feed pellets containing edible oil, wherein the amount of edible oil is 1-50% by weight of the loaded feed pellets.
